(19) United States
(12) Patent Application Publication
(10) Pub. No.: US 2013/0019012 A1
(43) Pub. Date: Jan. 17, 2013

(54) IMS Guest Registration for Non-IMS Users

(71) Applicants: Eric Harold Henrikson, Redmond, WA (US); Douglas Varney, Naperville, IL (US)

(72) Inventors: Eric Harold Henrikson, Redmond, WA (US); Douglas Varney, Naperville, IL (US)

(73) Assignee: Alcatel-Lucent USA Inc., Murray Hill, NJ (US)

(21) Appl. No.: 13/179,934

(22) Filed: Jul. 11, 2011

(51) Int. Cl. G06F 15/173

(52) U.S. Cl. 709/225; 709/223

(57) ABSTRACT

Methods, systems, and apparatuses for IMS guest registration for non-IMS users are provided. The method may be performed by receiving a registration request from a non-IMS user for access to an IMS network, the registration request indicating a domain name of a non-IMS system; determining whether the domain name indicated by the registration request matches a wildcard identifier, wherein the wildcard identifier may be indicative of a non-IMS system authorized to access the IMS network; and initiating a guest registration process if the domain name matches the wildcard identifier. The non-IMS user is authenticated in the IMS network via a non-IMS authentication entity.

### FIELD OF THE INVENTION

This invention relates to a guest user registration system in an Internet Protocol Multimedia Subsystem (IMS) networking architecture.

### BACKGROUND

The Internet Protocol Multimedia Subsystem (IMS) is a standardized next generation networking architecture for providing multimedia services in mobile/wireless and fixed/wire-line communication networks. The IMS uses the Internet protocol (IP) for packet-data communications generally, and voice over IP (VoIP) for voice communications, based on a 3GPP/3GPP2 standardized implementation of session initiation protocol (SIP). (SIP is a signaling protocol used for establishing sessions, such as a two-way telephone call or multi-party phone conference, in an IP network.) The IMS works with any packet switched network, both wire-line based and wireless, such as GPRS, UMTS, CDMA2000, and WiMAX. Legacy circuit-switched phone systems and similar networks (e.g., POTS, GSM) are supported through gateways. The IMS includes session control, connection control, and an application services framework along with subscriber and services data. It enables the use of new converged voice and data services, while facilitating the interoperability of these converged services between subscribers.

In an IMS-based network (also referred to herein as an “IMS network”), as is generally the case with other communication networks, user terminals provide a means for users to communicate with one another over the network(s). Each terminal is an electronic device with hardware and/or software-based functionality for communicating over a network, and typically includes user input/output means such as a physical or virtual keyboard/keypad and display. Examples include computer terminals, as well as wireless units such as mobile phones, wireless PDAs, wireless devices with high-speed data transfer capabilities, such as those compliant with “3-G” or “4-G” standards, “WiFi”-equipped computer terminals, and the like. When communications are initiated between terminals, e.g., a calling terminal initiates communications with a called terminal, the network attempts to open a communication channel between the two terminals according to various automatic signaling procedures.

The IMS network architecture generally allows inter-working with “non-IMS” networks and the associated non-IMS end-user equipment. With the fast growing base of non-IMS IP broadband subscribers, who are now often equipped to perform media-rich voice and video (SIP) sessions over IP, it is advantageous for IMS subscribers (who are oftentimes large-scale telecommunications providers and institutional customers) to be able to inter-work with non-IMS (but still SIP-enabled) broadband subscribers. Non-IMS subscribers (also referred to herein as non-IMS users) may also wish to take advantage of the managed quality of service (QoS) of an IMS network even though they are accessing the IMS network from the public IP network. For example, non-IMS users may wish to use the routing capabilities of an IMS network to connect with users across various types of networks. Non-IMS users also may want to take advantage of IMS applications such as Web services, click-to-dial calling capabilities and the like.

However, there are guest registration procedures that non-IMS users must follow to register in an IMS network, and associated authentication requirements for user-provided guest subscription data. These guest registration procedures often cause significant access-time delays, as establishing a guest registration typically requires an administrative request for an IMS service provider to create a subscriber entry in an IMS subscriber database (e.g., an IMS network home subscriber server (HSS)). Therefore, there is a need to allow non-IMS users access to an IMS network without the delays of current non-IMS registration and authentication procedures. There is also a need to provide an authentication mechanism that would streamline IMS network access.

### SUMMARY OF THE INVENTION

An improved system, method and article of manufacture for IMS guest registration for non-IMS users comprises receiving a registration request from a non-IMS user for access to an IMS network, the registration request indicating a domain name of a non-IMS system, determining whether the domain name indicated by the registration request matches a wildcard identifier, wherein the wildcard identifier may be indicative of a non-IMS system authorized to access the IMS network, and initiating a guest registration process if the domain name matches the wildcard identifier.

In accordance with an embodiment, the wildcard identifier comprises a user portion including a wildcard indicator and a host portion including a domain name for a non-IMS system authorized to use the IMS network.

In accordance with an embodiment, the registration request includes an authentication credential for the non-IMS user, and the method further comprises validating the authentication credential of the non-IMS user, and generating a guest registration entry for the non-IMS user for access to the IMS network.

In accordance with an embodiment, the method further comprises accessing a non-IMS server to validate the authentication credential and storing the guest registration entry for the non-IMS user, the guest registration entry being based on a unique PUID for the non-IMS user.

These and other advantages of the invention will be apparent to those of ordinary skill in the art by reference to the following detailed description and the accompanying drawings.

### BRIEF DESCRIPTION OF THE DRAWINGS

FIG. 1 is a schematic diagram of an IMS network environment suitable for implementing the various embodiments;

FIG. 2 is a flowchart illustrating steps of a guest registration method according to an embodiment;

FIG. 3 is a call-flow chart illustrating an IMS network guest registration method according to an embodiment; and

FIG. 4 is a high-level block diagram of an exemplary computer that may be used for implementing the various embodiments.

### DETAILED DESCRIPTION

The various embodiments described herein allow for Application and Content Providers (ACP) and their non-IMS users to obtain guest registrations for the purposes of utilizing an IMS network. After a non-IMS user receives a guest registration, an ACP may initiate requests to a non-IMS user via the IMS network as well as to other destinations utilizing the IMS network. For example, a non-IMS user with a guest registration may utilize the IMS network for IMS applications (e.g., click-to-dial capability), where the non-IMS user is one party and the other party resides in another network (such as IMS subscriber, PSTN user, mobile phone user, VoIP provider, etc).

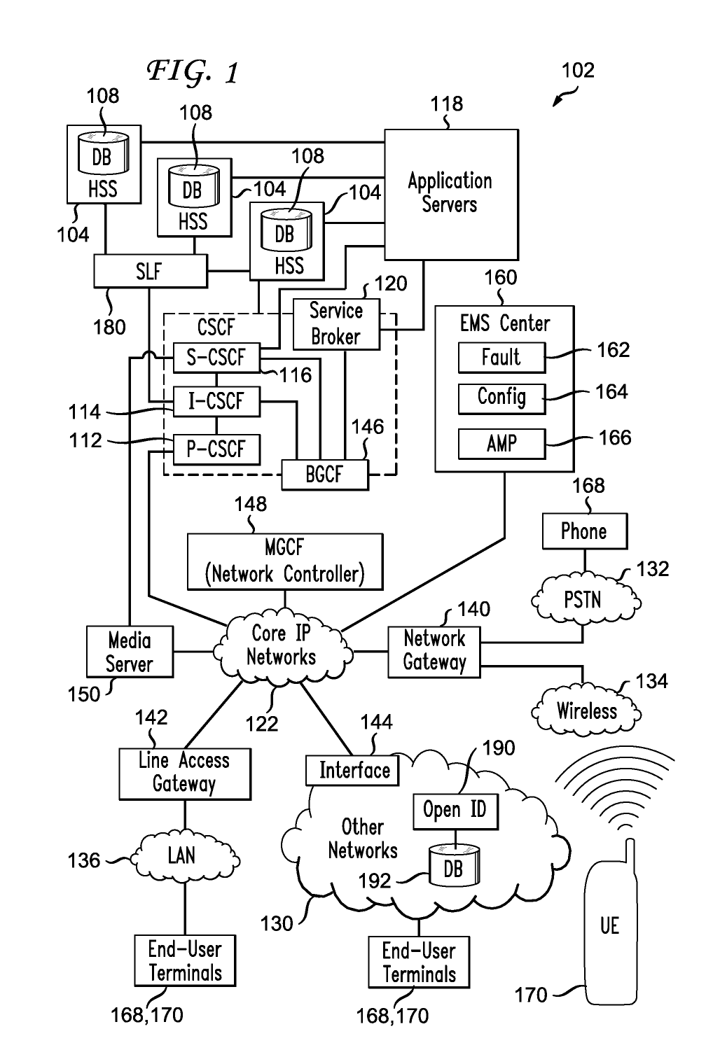

FIG. 1 is a schematic diagram of an IMS network environment suitable for implementing the various embodiments. As the term is used herein according to its customary and normal meaning, an IMS network 102 is an IP multimedia and telephony core network as generally defined by 3GPP and 3GPP2 standards and organizations based on IETF Internet protocols. FIG. 1 illustrates, as a simplified example, the typical components that comprise an IMS network, and how they relate to one another. The IMS control architecture includes a home subscriber server (HSS) 104 and a call session control function (CSCF) 110, and may generally be divided into a services/application layer, an IMS layer, and a transport layer. The HSS 104 in this case is the central repository of all subscriber or user-specific data 108, including user authorizations, service permissions, service profiles, and preferences. The HSS 104 integrates several functions/elements, including IMS subscriber authentication and authorization. The CSCF 110 carries out the primary SIP signaling functions in the network 102. The CSCF 110 includes several types of SIP servers, including a proxy-CSCF (P-CSCF) server 112 (which is the first point of contact for a device and controls authentication), an interrogating-CSCF (I-CSCF) server 114 (which is the entry point of all SIP messages), and a serving CSCF (S-CSCF) server 116, which manages session control functions. Application servers 118 host and execute services, and interface with the CSCF 110 using SIP, optionally through a service broker function 120. This allows third-party providers to easily integrate and deploy their value-added services on the IMS infrastructure. Examples include caller ID-related services, call waiting, call holding, click-to-dial, push-to-talk, conference call servers, voicemail, instant messaging, call blocking, and call forwarding.

The CSCF 110 is connected to a broadband IP network 122, which acts as the core of the IMS network 102 for interconnecting and/or interfacing with other networks 130 and with other network elements that operate at the IMS transport layer. Thus, the IMS network 102 may include and/or be connected with a number of IP-based and other networks (e.g., non-IMS networks) such as the Internet, DSL networks, public switched telephone networks (PSTN) 132 and other wire-line networks, wireless networks 134 such as those using CDMA, GSM, IEEE 802.1 lx, and/or UMTS communications or the like, and local area networks (LAN) 136. Typically, the IMS core network 122 is interfaced with other networks 130, 132, 134, 136 by way of a network gateway 140, line access gateway 142, or other hardware/software interface 144.

In the example shown in FIG. 1, portions of the CSCF 110 are connected to the core IP network 122 by way of one or more gateway elements, such as a breakout gateway control function (BGCF) 146 and a media gateway controller function (MGCF) or other network controller 148. The BGCF 146 is an SIP server that includes routing functionality based on telephone numbers. The MGCF 148 provides a media gateway control (MGC) function for VoIP purposes, thereby providing the centralized call control function for the multiple network gateways 140, 142, 144. Additionally, the MGCF 148 acts as a bridge between third-generation converged multi-service networks and legacy circuit switched networks. For example, the MGCF 148 may carry out the call processing functions necessary to translate between SIP-based wireline or wireless calls in the IMS network and ISUP calls in a PSTN 132.

The IMS network 102 may also include a media server 150 and an EMS center 160. The media server 150 supports SIP call control of RTP (real time packet) sessions, is compatible with circuit switched networks in addition to SIP-based packet switched networks for both wire-line and wireless networks, and may provide enhanced media-control services such as announcement players, tone generators, conferencing, text-to-speech synthesizers, and the like. The EMS (element management system) center 160 includes elements for fault 162, configuration 164, and operations and maintenance 166 functions. For example, the EMS elements 162, 164, 166 may manage one or more of a specific type of network element, provide data processing and management functions, and provision multiple services across multiple regions and multiple networks.

Subscribers communicate over the IMS network 102 using end-user communication terminals 168, 170. The terminals 168, 170 are electronic devices capable of communicating with one another over the network(s) 102, 132, 134, 136, and may include, for example, computer terminals, wire-line connected communication devices such as conventional telephones and enhanced/multimedia-capable telephones 168, and/or wireless units 170 such as mobile phones, wireless PDA's, wireless devices with high-speed data transfer capabilities, such as those compliant with “3-G” or “4-G” standards, “WiFi”-equipped computer terminals, and the like. The terminals 168, 170 communicate with one another over the networks in a standard manner, depending on the particular networks used and the particular type of terminals. For example, in the case of wireless units 170 and a wireless network 134, the network 134 may include one or more fixed base stations (not shown) having various transceivers and antennae for wireless, radio-frequency (RF) communications with the wireless units over one or more RF channels, in a manner based on the wireless communication method and protocol used.

For simplicity of illustration, some intermediate network elements such as access gateways and server nodes are not shown, however, information regarding the operation of such elements is generally known to those skilled in the art. One skilled in the art will also recognize that the various elements, and functions described herein as being performed by the various elements may, in actuality, be combined and are described as discrete elements and functions solely for the purposes of simplicity and ease of understanding.

According to the various embodiments, an improved solution for guest registering non-IMS users for access to an IMS network 102 includes provisioning the HSS 104 with a predetermined single Public User Identity (PUID) entry for each non-IMS system that has an arrangement to use the IMS network 102. In one embodiment, the single PUID entry is a “wildcard” PUID that comprises an SIP uniform resource identifier (SIP URI), where a user portion is represented by a pre-selected wildcard identifier, and a host portion identifies a domain name for an authorized non-IMS system. The wildcard PUID may also be provisioned to a subscriber location function (SLF) for use in finding an HSS 104 designated for guest registration when, for example, there are multiple HSS 104 in the IMS network 102.

In one embodiment, the HSS 104, which typically stores user-related data for IMS network subscribers, does not store authentication information related to the wildcard PUID. Instead, the S-CSCF 116 communicates with a non-IMS authentication server for non-IMS user authentication information. For example, the non-IMS authentication server may be a server that is already used for authenticating non-IMS users in other networks 130, 132, 134, 136 such as an OpenID server 190 (with an accompanying subscriber database 192). In addition, the S-CSCF 116 also includes a predetermined list of guest domain names defining which non-IMS systems are permitted to use the IMS network 102.

A guest registration method according to the various embodiments provides a non-IMS subscriber with a unique guest registration entry that is created at the S-CSCF 116, contact information at a P-CSCF 112, and an S-CSCF 116 address within the HSS 104 such that later SIP requests to or from the non-IMS user can be routed through the IMS network. The non-IMS user may take advantage of the IMS network to connect with endpoints in multiple networks, use IMS applications and other capabilities. The non-IMS user may also be identified by its guest registration for incoming SIP requests received through the IMS network.

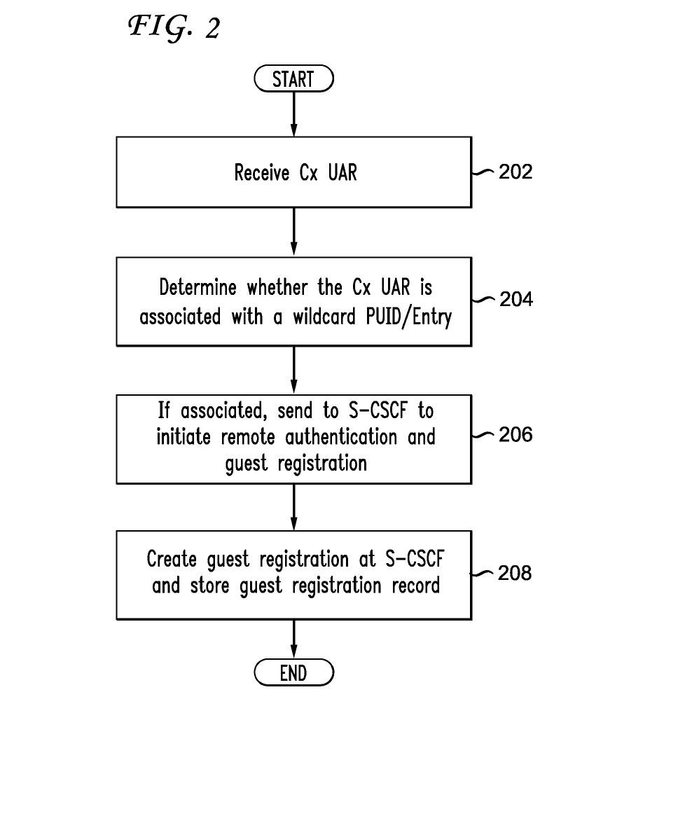

FIG. 2 is a flowchart illustrating a guest registration method according to an embodiment. At 202, the HSS 104 receives a Cx user-authorization-request (UAR) from the I-CSCF 114 triggered by a non-IMS user sending a REGISTER request via a P-CSCF 112 entry point. The HSS 104 determines whether the domain name in the received UAR is associated with a wildcard PUID at 204. At 206, the HSS 104 locates an S-CSCF 116 associated with the wildcard entry to initiate remote authentication (e.g., wherein the S-CSCF 116 accesses a non-IMS authentication server associated with a domain name of the received UAR). The S-CSCF 116 then creates a guest registration entry (e.g., a registration entry based on the non-IMS user's unique PUID, rather than a wildcard PUID) and informs the HSS 104, which is configured to store the address of the S-CSCF 116 associated with the wildcard PUID at 208.

When a next REGISTER request is received for a wildcard PUID that already has an associated guest registration (i.e., a guest registration entry created for a specific PUID that matches a wildcard PUID for the same domain name), the I-CSCF 114 is informed by the HSS 104 of the S-CSCF 116 that has been assigned for the wildcard PUID. As such, it is not necessary to look-up an S-CSCF 116 for the wildcard entry or to inform the HSS 104 of the address of the associated S-CSCF 116 (as the S-CSCF address is already known to the HSS 104).

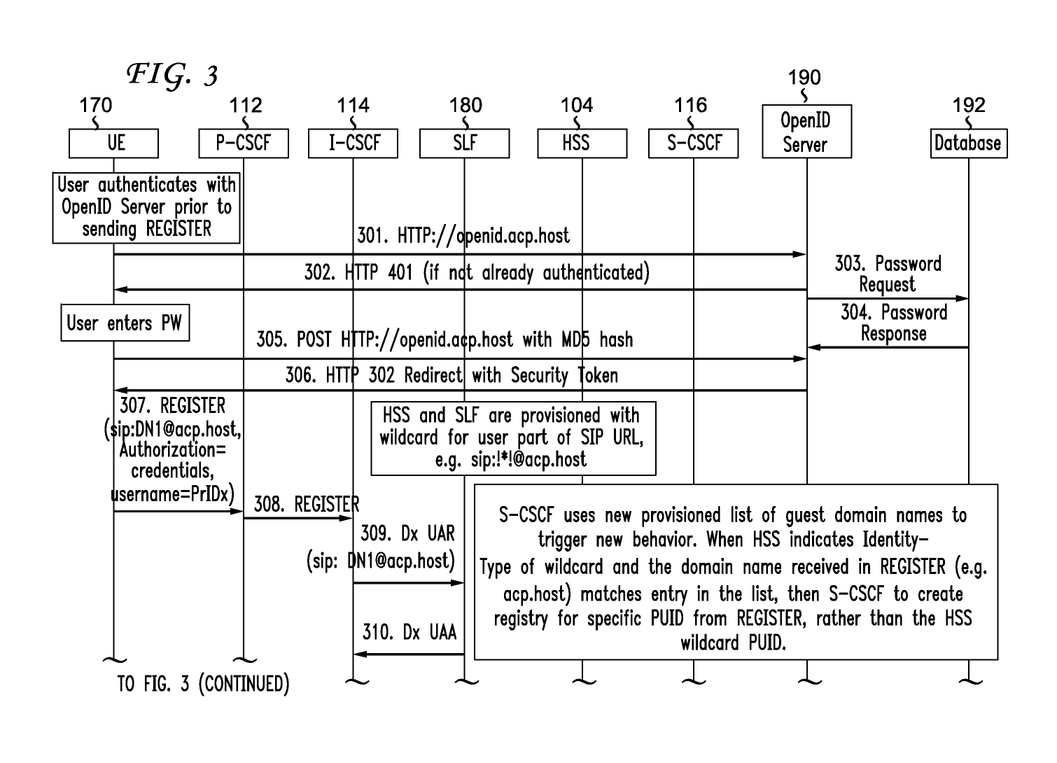

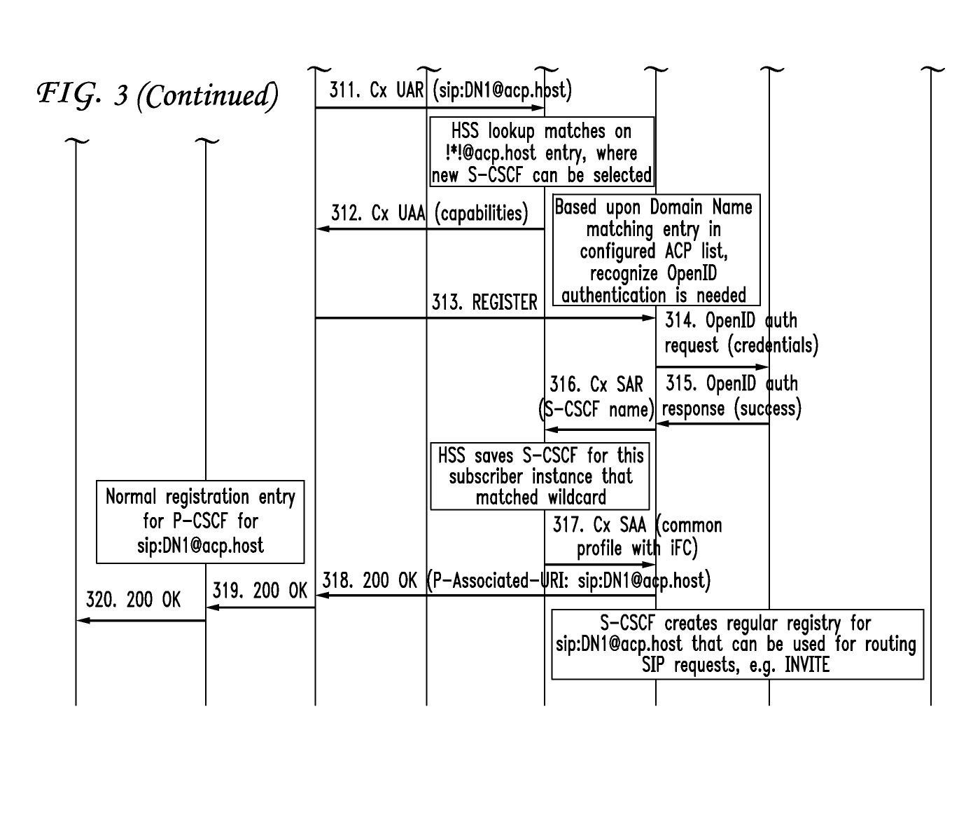

FIG. 3 is a call-flow chart which schematically illustrates an IMS network guest registration method according to an embodiment. The chart schematically illustrates in columns the method performed by each node involved in the guest registration method. All of the methods illustrated in the same column are performed by the network node schematically indicated at the top of the column. Respectively, the columns illustrate methods to be performed by user equipment (sometimes referred to as a UE or non-IMS user) 170, the P-CSCF 112, I-CSCF 114, SLF 180, HSS 104, S-CSCF 116, OpenID server 190 and subscriber database 192.

In one embodiment, a non-IMS user 170 is authenticated by a non-IMS authentication server prior to initiating a registration request. For example, at 301 the non-IMS user may be authenticated by an OpenID server 190 (e.g, located at a Web address, http://openid.acp.host), such as those currently used by many Internet providers. If the non-IMS user has not been pre-authenticated, the OpenID server may return an HTTP status code 401 message (i.e., indicating that the non-IMS user is currently unauthorized) at 302. Upon receipt of the non-IMS user's password, the OpenID server 190 may access a subscriber database 192 containing user-related data to authenticate the user at 303. For example, if the non-IMS user's password matches a valid password in the subscriber database 192, the OpenID server 190 receives a password response (e.g., indicating the receipt of a valid password) from the subscriber database at 304. At 305, the authenticated non-IMS user may then re-send the authentication request to the OpenID server 190 to receive a security credential, such as a valid security token at 306.

After being authenticated by a non-IMS server, the non-IMS user may register as a guest user of the IMS network 102. In one embodiment, the IMS network 102 is adapted for non-IMS user registration such that the HSS 104 includes a database or look-up table comprising wildcard PUID entries. The wildcard PUID entries identify each non-IMS system that is authorized to use the IMS network. For example, the wildcard PUID may comprise a wildcard identifier (e.g., sip:!.*!) as the user portion of the PUID and a domain name (e.g., acp.host) that identifies an authorized non-IMS system in the host portion of the PUID. As such, the HSS 104 will associate the wildcard PUID, sip: !.*!@acp.host, with any non-IMS user from the “acp.host” domain.

In another embodiment, the S-CSCF 116 includes a domain name list of authorized non-IMS systems. For example, when the HSS 104 determines that a received PUID (i.e., from a non-IMS user REGISTER request) is associated with a wildcard PUID, the S-CSCF 116 is adapted to verify authentication credentials based on the received PUID domain name and create a guest registration entry based on the received PUID (rather than the associated wildcard PUID). The non-IMS user may then utilize the guest registration for routing SIP requests in the IMS network.

A registration process according to an embodiment is illustrated by 307-320 of FIG. 3. In one embodiment, the P-CSCF 112 receives a REGISTER request from a non-IMS user at 307. The REGISTER request may include a variety of information identifying the user such as, for example, an SIP, authentication credentials, and a user name. When the P-CSCF receives the REGISTER request, the P-CSCF performs a DNS look up (i.e., to determine what type of record), and forwards the REGISTER request to the appropriate I-CSCF 114 at 308.

Upon receipt of the REGISTER request, the I-CSCF 114 sends a Dx UAR to the SLF 180 at 309 to identify an HSS 104 for non-user registration in, for example, an IMS network 102 that includes a plurality of HSS 104. In one embodiment, the SLF 180 includes a database or look-up table of wildcard PUID entries, and may associate the received PUID with a wildcard entry to determine of the correct HSS 104. After the correct HSS 104 has been located, the SLF 180 may inform the I-CSCF 114 at 310.

The I-CSCF 114 accesses the HSS 104 at 311 to determine either an S-CSCF 116 associated with the wildcard PUID (i.e., the HSS 104 matches the received PUID domain name with a wildcard entry) or the capabilities of available S-CSCF 116 (if no S-CSCF 116 is currently assigned for the wildcard PUID) at 312. At 313, the I-CSCF 114 then either forwards the REGISTER request to an assigned guest registration S-CSCF 116 or chooses an S-CSCF 116 and then forwards the request to the selected S-CSCF 116.

In one embodiment, the authorization parameters may require the S-CSCF 116 to authenticate the non-IMS user prior to creating a guest registration entry. For example, the S-CSCF 116 may be adapted to verify the non-IMS user's authentication credentials by querying an OpenID server 190 at 314 and, if the credentials are valid, receive an OpenID authentication response indicating a successful validation from the OpenID server 190 at 315. Upon validation, the S-CSCF 116 sends a server authorization request (e.g., indicating that the S-CSCF 116 matched the wildcard entry) to the HSS 104 at 316. In one embodiment, the HSS 104 saves the S-CSCF 116 as the authorized server for the wildcard entry, and sends a server authorization answer (SAA) to the S-CSCF 116 at 317. The S-CSCF then creates a guest registration entry (e.g., sip:DN1@acp.host) for the non-IMS user that can be used for routing SIP requests. For example, when the REGISTER request matches an entry in the list of guest domain names, the S-CSCF 116 is adapted to create a guest registration entry for the unique PUID of the non-IMS user, rather than for the wildcard entry utilized by the HSS 104. The S-CSCF 116 may then communicate a confirmation message regarding the new guest registration entry to the non-IMS user via the I-CSCF and the P-CSCF at 318-320.

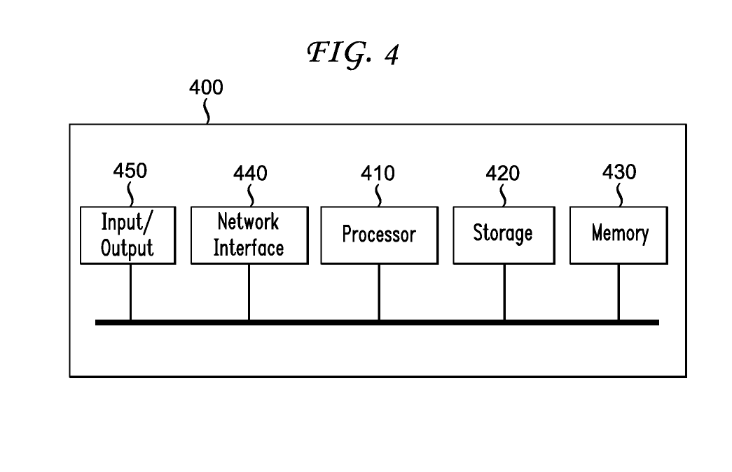

The above-described methods may be implemented on a computer using well-known computer processors, memory units, storage devices, computer software, and other components. A high-level block diagram of such a computer is illustrated in FIG. 4. Computer 400 contains a processor 410, which controls the overall operation of the computer 400 by executing computer program instructions which define such operation. The computer program instructions may be stored in a storage device 420 (e.g., magnetic disk) and loaded into memory 430 when execution of the computer program instructions is desired. Thus, the methods of FIGS. 2 & 3 may be defined by the computer program instructions stored in the memory 430 and/or storage 420 and controlled by the processor 410 executing the computer program instructions. The computer 400 may include one or more network interfaces 440 for communicating with other devices via a network for implementing the methods of FIGS. 2 & 3. The computer 400 may also include other input/output devices 450 that enable user interaction with the computer 400 (e.g., display, keyboard, mouse, speakers, buttons, etc.). One skilled in the art will recognize that an implementation of an actual computer could contain other components as well, and that FIG. 4 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. A method comprising:
receiving a registration request from a non-IMS user for access to an IMS network, the registration request indicating a domain name of a non-IMS system;
determining whether the domain name indicated by the registration request matches a wildcard identifier; and
initiating a guest registration process if the domain name matches the wildcard identifier.

2. The method of claim 1, wherein the wildcard identifier being indicative of a non-IMS system authorized to access the IMS network.

3. The method of claim 1, wherein the wildcard identifier comprises a user portion including a wildcard indicator and a host portion including a domain name for a non-IMS system authorized to use the IMS network.

4. The method of claim 1, further comprising associating the domain name indicated by the registration request with a guest profile and authorization parameters.

5. The method of claim 1, wherein the registration request includes an authentication credential for the non-IMS user.

6. The method of claim 5 further comprising:
validating the authentication credential of the non-IMS user; and
generating a guest registration entry for the non-IMS user for access to the IMS network.

7. The method of claim 6, further comprising accessing a non-IMS server to validate the authentication credential.

8. The method of claim 6, further comprising storing the guest registration entry for the non-IMS user.

9. The method of claim 6, wherein the guest registration entry is based on a unique PUID for the non-IMS user.

10. A system comprising:
a server adapted to:
receive a registration request from a non-IMS user for access to an IMS network, the registration request indicating a domain name of a non-IMS system;
determine whether the domain name indicated by the registration request matches a wildcard identifier; and
initiate a guest registration process if the domain name matches the wildcard identifier.

11. The server of claim 10, wherein the wildcard identifier being indicative of a non-IMS system authorized to access the IMS network.

12. The server of claim 10, wherein the wildcard identifier comprises a user portion including a wildcard indicator and a host portion including a domain name for a non-IMS system authorized to use the IMS network.

13. The server of claim 10, further adapted to associate the domain name indicated by the registration request with a guest profile and authorization parameters.

14. The server of claim 10, wherein the registration request includes an authentication credential for the non-IMS user.

15. The server of claim 14 further adapted to:
validate the authentication credential of the non-IMS user; and
generate a guest registration entry for the non-IMS user for access to the IMS network.

16. The server of claim 15, further adapted to access a non-IMS server to validate the authentication credential.

17. The server of claim 15, further adapted to store the guest registration entry for the non-IMS user.

18. The server of claim 15, wherein the guest registration entry is based on a unique PUID for the non-IMS user.

19. An article of manufacture including a non-transitory computer-readable medium having instructions stored thereon, that in response to execution by a computing device causes the computing device to perform operations comprising:
receiving a registration request from a non-IMS user for access to an IMS network, the registration request indicating a domain name of a non-IMS system;
determining whether the domain name indicated by the registration request matches a wildcard identifier; and
initiating a guest registration process if the domain name matches the wildcard identifier.

20. The article of manufacture of claim 19, wherein the wildcard identifier being indicative of a non-IMS system authorized to access the IMS network.

21. The article of manufacture of claim 19, wherein the wildcard identifier comprises a user portion including a wildcard indicator and a host portion including a domain name for a non-IMS system authorized to use the IMS network.

22. The article of manufacture of claim 19, further comprising associating the domain name indicated by the registration request with a guest profile and authorization parameters.

23. The article of manufacture of claim 19, wherein the registration request includes an authentication credential for the non-IMS user.

24. The article of manufacture of claim 23 further comprising:
validating the authentication credential of the non-IMS user; and
generating a guest registration entry for the non-IMS user for access to the IMS network.

25. The article of manufacture of claim 24, further comprising accessing a non-IMS server to validate the authentication credential.

26. The article of manufacture of claim 24, further comprising storing the guest registration entry for the non-IMS user.

27. The article of manufacture of claim 24, wherein the guest registration entry is based on a unique PUID for the non-IMS user.
